(19) United States
(12) Patent Application Publication
(10) Pub. No.: US 2026/0189146 A1
(43) Pub. Date: Jul. 2, 2026

(54) POWER SUPPLY WITH HIGH FREQUENCY, HIGH EFFICIENCY, AND ULTRAFAST DYNAMIC PERFORMANCE

(71) Applicant: MetaPWR Electronics Co., Ltd., Shanghai (CN)

(72) Inventors: Mingzhun ZHANG, Shanghai (CN); Xiaoni Xin, Shanghai (CN); Yahong Xiong, Shanghai (CN)

(73) Assignee: MetaPWR Electronics Co., Ltd., Shanghai (CN)

(21) Appl. No.: 19/435,756

(22) Filed: Dec. 30, 2025

(30) Foreign Application Priority Data
Dec. 31, 2024 (CN) 202411984941.3

(51) Int. Cl. H02M 3/158; H01F 27/30; H02M 3/00

(52) U.S. Cl. CPC H02M 3/1584; H01F 27/306; H02M 3/003

(57) ABSTRACT

The present application discloses a multiphase power supply module structure for high-frequency multiphase BUCK circuits with paralleled connection and anti-coupling technology. On the one hand, the multiphase high-frequency BUCK circuits are integrated in a single power supply module; on the other hand, by optimizing the magnetic core structure and the winding structure, the output inductance of the multiphase BUCK circuits is reversely coupled, the volume of the magnetic component is further reduced, and the power density and dynamic performance of the multi-phase power supply module are improved.

### CROSS-REFERENCE TO RELATED APPLICATION

This application claims the priority benefit of China application serial no. CN202411984941.3 filed on Dec. 31, 2024. The entirety of the above-mentioned patent application is hereby incorporated by reference herein and made a part of this specification.

### BACKGROUND

### Technical Field

The present invention belongs to the technical field of high-frequency power supplies, and in particular relates to a power supply module with high frequency, high efficiency and ultrafast dynamic performance.

### Description of Related Art

In recent years, with the development of technologies such as data center, artificial intelligence, and supercomputers, more and more powerful ASICs are used to obtain applications, such as CPU, GPU, TPU, NPU, ML, AI accelerator, network switch, server, etc. which consume a large amount of current, such as thousands of amperes; and these ASICs have higher and higher dynamic response requirements for power supply. This load is traditionally supplied using a multi-phase voltage regulator module (VRM-Voltage Regulation Modules). With the advancement of semiconductor technology, a power supply power of the ASIC is further increased, and a power supply voltage required by the ASIC continues to decrease, and therefore, a power supply current of the ASIC continues to increase; as the ASIC supply current increases, a output power and a output current of the VRM also increase; when the output current of the VRM becomes larger and larger, the direct current loss becomes larger and larger, and the impact on the efficiency of the direct current loss becomes larger and larger; under a large current, the switching frequency is negatively correlated with the efficiency, that is, when the switching frequency is higher, the efficiency is lower; therefore, when the output current of the VRM becomes larger and larger, in order to meet the requirements of efficiency, the switching frequency is ideally as low as possible; however, the switching frequency is positively correlated with the dynamic response, that is, the higher the switching frequency, the higher the bandwidth of the control loop, and the faster the dynamic response of the VRM output voltage; therefore, from the perspective of efficiency, the switching frequency is ideally as low as possible when it's in the large current conditions; however, from the perspective of efficiency, the switching frequency is ideally as high as possible; a contradiction between the efficiency and the dynamic response is a difficulty in the VRM design;

The present application adopts the multi-phase technology of high frequency (3 Mhz and above), that is, the number of phases is increased, the current magnitude of a single-phase is reduced, the switching frequency is improved, and the above technical problem is ideally resolved.

An anti-coupling inductor technology has a relatively low leakage inductance, and therefore has a relatively fast transient response; meanwhile, the anti-coupling inductor has a relatively high steady-state equivalent inductance, which is beneficial to the improvement of efficiency; that is, the anti-coupling inductor technology can meet the requirements of transient performance, and can also improve the efficiency; therefore the anti-coupling inductor technology is a hot spot of the VRM design.

However, since the demand of the XPU on the supply voltage is getting lower and lower, the ratio of the output voltage to the input voltage of the multi-phase BUCK circuit in the VRM, that is, a duty cycle is also getting smaller and smaller; therefore, how to obtain better anti-coupling performance when the duty cycle is getting smaller and smaller is also a difficulty in the design of this field.

Based on the multi-phase technology with high frequency (3 Mhz and above), the present application can further improve the efficiency and improve the dynamic performance by using the multi-phase anti-coupling inductor, and effectively solve the above technical problems.

### SUMMARY

In view of the above, one of the objectives of the application is to provide a multi-phase power supply module, wherein the multi-phase power supply module is connected in parallel by using a multi-phase BUCK circuit, and the multi-phase power supply module is at least four phases; the multi-phase power supply module comprises a top assembly and a middle assembly; the middle assembly is arranged on a bottom surface of the top assembly, and the middle assembly is electrically connected to the top assembly;
the middle assembly comprises a magnetic core, at least four windings and an electrical connector; the magnetic core comprises at least four magnetic columns, a first side surface and a third side surface opposite to each other, a second side surface and a fourth side surface opposite to each other, and a top surface and a bottom surface opposite to each other; the electrical connector is disposed on a side surface of the magnetic core; and
the windings are all “U”-shaped windings, and each “U”-shaped winding includes two top surfaces and one bottom surface; each of the windings is clamped on a corresponding magnetic column in the same direction; both top surfaces of each of the “U”-shaped windings are electrically connected to the top assembly.

Preferably, the magnetic core comprises a first magnetic core and a second magnetic core; the second magnetic core includes a erected portion and at least one horizontal portion, the erected portion and the horizontal portions are vertically disposed; the first magnetic core is in a shape of “□”, the first magnetic core includes a middle space, the second magnetic core is disposed in the middle space of the first magnetic core, and the middle space of the first magnetic core is divided into at least four windows.

Preferably, each of the windings comprises two erected portions and a horizontal portion, and the two erected portions are respectively disposed in two adjacent windows.

Preferably, current directions flowing through each of the windings are the same.

Preferably, an air gap is provided between the first magnetic core and the second magnetic core.

Preferably, the magnetic core is a magnetic material having a high magnetic permeability.

Preferably, the magnetic core further comprises a third magnetic core, and the third magnetic core is disposed between the first magnetic core and the second magnetic core; and the third magnetic core is a magnetic material having a low magnetic permeability.

Preferably, the top assembly comprises a top substrate, an integrated power stage, and an input capacitor; the top substrate includes a top surface and a bottom surface opposite to each other, the integrated power stage and the input capacitor are disposed on the top substrate; the integrated power stage includes at least two high-side switches, at least two low-side switches, and a driving/logic circuit; the driving/logic circuit is configured to drive the high-side switches and the low-side switches to be turned on and turned off.

Preferably, the integrated power stage and the input capacitor are arranged on the top surface of the top substrate; the top assembly further comprises a molding compound, the integrated power stage comprises an integrated Dr. MOS, and the molding compound covers the integrated Dr. MOS and the input capacitor.

Preferably, the input capacitors are arranged around the integrated power stage and between the integrated power stages, and the input capacitor is an MLCC capacitor or a silicon capacitor.

Preferably, a top surface of the is provided with a thermal pad, and the thermal pad is thermally connected to a top surface of the integrated power stage through a via.

Preferably, in the integrated power stage, one of the high-side switches and one of the low-side switches are electrically connected to a SW point, and each of a plurality of the SW points is electrically connected to an input terminal of one of the windings through the top substrate.

Preferably, the electrical connector comprises a first power electrical connector, a second power electrical connector, an output electrical connector, and a signal electrical connector; the first power electrical connector is electrically connected to an end of the high-side switches by means of the top substrate, and the second power electrical connector is electrically connected to an end of the low-side switches by means of the top substrate; and the output electrical connector is electrically connected to an output terminal of each of the windings by means of the top substrate.

Preferably, the multi-phase power supply module, further comprising a bottom assembly; the bottom assembly comprises a bottom substrate, a power metal block, a winding metal block, an output capacitor, and a molding compound; the power metal block comprises a first power metal block and a second power metal block, the bottom substrate comprises a top surface and a bottom surface opposite to each other, the power metal block, the winding metal block, and the output capacitor are arranged on the top surface of the bottom substrate; the molding compound covers the power metal block, the winding metal block, and the output capacitor; the power metal block is electrically connected to a part of the electrical connector, and the winding metal block is electrically connected to one of the windings.

Preferably, the number of the winding metal blocks is less than or equal to the number of the windings.

Preferably, projections of each winding metal block and the winding electrically connected to the projections on the top surface of the bottom substrate at least partially overlap.

Preferably, a top surface of the molding compound is provided with a bus pin, and the bus pin is used for converging the current in the winding.

Preferably, the magnetic core comprises a first magnetic core and a second magnetic core, the first magnetic core and the second magnetic core are both comb-shaped, and each of the windings is clamped on one tooth of comb in the same direction.

Preferably, the teeth of comb of the first magnetic core are arranged opposite to the teeth of comb of the second magnetic core.

Preferably, the magnetic core further comprises a third magnetic core, and the third magnetic core is disposed between the teeth of comb of the first magnetic core and the teeth of comb of the second magnetic core.

Preferably, the first magnetic core and the second magnetic core are magnetic materials with high magnetic permeability; and the third magnetic core is a powder core material with low magnetic permeability.

Preferably, an internal pin is provided on the bottom surface of the top assembly, and the internal pin comprises a SW pin, a VIN pin, a GND pin, and a Sig pin;
a plurality of the SW pins are provided in a middle region of the bottom surface of the top assembly and are electrically connected to a winding pin; a plurality of the VIN pins are disposed adjacently on a second side surface and a fourth side surface of the top assembly, and are electrically connected to the first power electrical connector; a plurality of the GND pins are disposed adjacently on the second side surface and the fourth side surface of the top assembly, and are electrically connected to the second power electrical connector; and a plurality of the Sig pins are disposed adjacently on a third side surface and a first side surface of the top assembly, and are electrically connected to the signal electrical connector.

A multi-phase power supply module, wherein the multi-phase power supply module is adopting a paralleled multi-phase BUCK circuit, and the multi-phase power supply module is at least four phases; the multi-phase power supply module comprises a top assembly, a middle assembly and a bottom assembly; the middle assembly is arranged between the top assembly and the bottom assembly, and the middle assembly is electrically connected to the top assembly and the bottom assembly;
the middle assembly comprises a magnetic core, at least four windings, and an electrical connector; the magnetic core comprises at least four magnetic columns, a first side surface and a third side surface opposite to each other, a second side surface and a fourth side surface opposite to each other, and a top surface and a bottom surface opposite to each other; the electrical connector is disposed on a side surface of the magnetic core; each of the windings is an “I”-shaped winding, each winding passes through the top surface and the bottom surface of the magnetic core, and is electrically connected to the top assembly and the bottom assembly respectively; the at least four windings are arranged in a winding array; and
the top assembly includes a top substrate and an integrated power stage, the winding array is disposed below the integrated power stage.

Preferably, the top assembly further comprising an input capacitor; the top substrate comprises a top surface and a bottom surface opposite to each other, and the integrated power stage and the input capacitor is arranged on the top surface of the top substrate; the integrated power stage includes at least two high-side switches, at least two low-side switches, and a driving/logic circuit; the driving/logic circuit is configured to drive the high-side switches and the low-side switches to be turned on and turned off.

Preferably, the electrical connector comprises a first power electrical connector, a second power electrical connector, and a signal electrical connector; the first power electrical connector is electrically connected to an end of the high-side switches by means of the top substrate, and the second power electrical connector is electrically connected to an end of the low-side switches by means of the top substrate.

Preferably, the first power electrical connector is disposed on a second side surface and a fourth side surface of the magnetic core, the second power electrical connector is also disposed on the second side surface and the fourth side surface of the magnetic core, and the first power electrical connector and the second power electrical connector on the same side surface are adjacent to each other.

Preferably, the bottom assembly comprises a bottom substrate, a power metal block, a winding metal block, an output capacitor, and a molding compound; the power metal block comprises a first power metal block and a second power metal block, the bottom substrate comprises a top surface and a bottom surface opposite to each other, the power metal block, the winding metal block and the output capacitor are arranged on the top surface of the bottom substrate; the molding compound covers the power metal block, the winding metal block, and the output capacitor; the power metal block is electrically connected to a part of the electrical connector, and the winding metal block is electrically connected to the windings.

Preferably, the first power metal blocks are disposed adjacently on a second side surface and a fourth side surface of the bottom substrate; a plurality of the second power metal blocks are also disposed adjacently on the second side surface and the fourth side surface of the bottom substrate; the first power metal block and the second power metal block, which are disposed adjacently on the second side surface of the bottom substrate, are respectively electrically connected to the first power electrical connector and the second power electrical connector on the second side surface of the bottom substrate; and the first power metal block and the second power metal block, which are disposed adjacently on the fourth side surface of the bottom substrate, are respectively electrically connected to the first power electrical connector and the second power electrical connector on the fourth side surface of the bottom substrate.

Preferably, the bottom substrate has a bottom surface pin; the bottom surface pin comprises a VO pin, a GND pin, a VIN pin, and a Sig pin; a plurality of the VO pins are disposed at a central position of the bottom substrate, extend from adjacent to the second side surface of the bottom substrate to adjacent to the fourth side surface of the bottom substrate; a plurality of the GND pins are respectively disposed on two opposite sides of the VO pins, and also extend from adjacent to the second side surface of the bottom substrate to adjacent to the fourth side surface of the bottom substrate; a plurality of the VIN pins are disposed on a outer side of the GND pins away from the VO pins, and also extend from the adjacent to the second side surface of the bottom substrate to adjacent to the fourth side surface of the bottom substrate; and
a pin adjacent to the second side surface of the bottom substrate and a pin adjacent to the fourth side surface of the bottom substrate are used as the VO pins; a pin adjacent to a first side surface of the bottom substrate and a pin adjacent to a third side surface of the bottom substrate are used as a plurality of the Sig pins.

Preferably, the at least four windings are combined into an integrated winding by means of a lead frame or a stamping.

Compared with the prior art, the application has the following beneficial effects:

In the present application, a multi-phase power supply module structure is provided for a high-frequency multi-phase BUCK circuit with paralleled connection and anti-coupling technology, and on the one hand, the multi-phase BUCK circuit is integrated into one power supply module;

On the other hand, by optimizing the magnetic core structure and the winding structure, the output inductor of the multi-phase BUCK circuit is achieved anti-coupling, the volume of a magnetic component is further reduced, and the purpose of improving a power density of the multi-phase power supply module is achieved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A and FIG. 1B are schematic diagrams of a multi-phase BUCK circuit;

FIG. 2A to FIG. 2J are one embodiment of a multi-phase power supply module;

FIG. 3A to FIG. 3B are another embodiment of a multi-phase power supply module;

FIG. 4A to FIG. 4G are another embodiment of a multi-phase power supply module;

FIG. 5A to FIG. 5D are other embodiments of a magnetic assembly; and

FIG. 6A to FIG. 6B are another embodiment of a multi-phase power supply module.

### DESCRIPTION OF THE EMBODIMENTS

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

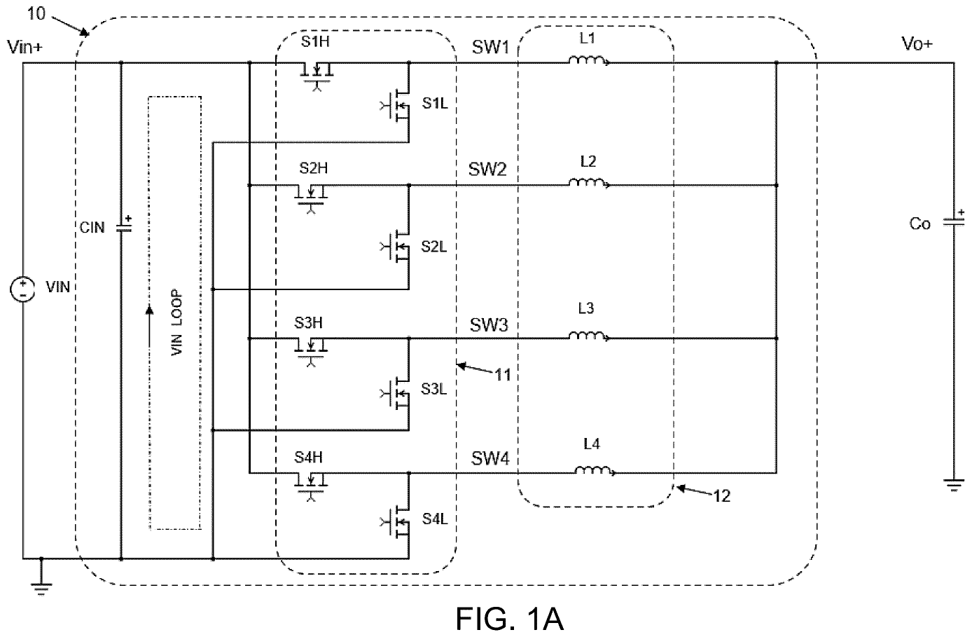

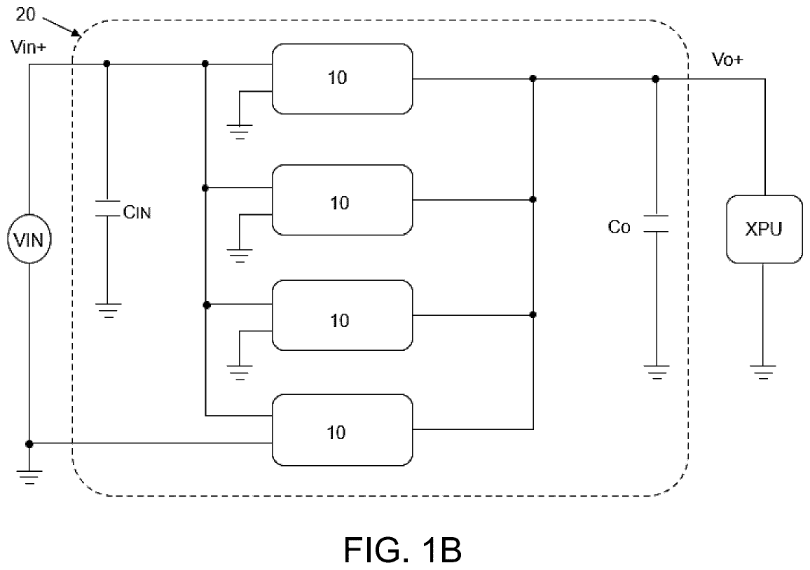

FIG. 1A is a schematic circuit diagram of a 4-phase voltage regulator module 10 (VRM) shown in the present disclosure. The 4-phase VRM 10 comprises a 4-phase Buck circuit electrically connected in parallel. The 4-phase Buck circuit comprises an integrated power stage 11, an output inductor unit 12, and an input capacitor Cin shared by the 4-phase Buck circuit. The integrated power stage 11 comprises four integrated Dr. MOSs; the output inductor unit 12 comprises four output inductors L1, L2, L3 and L4; each Dr. MOS includes a high-side MOSFET S1H, a low-side MOSFET S1L and a driving/logic circuit (not shown in the figure); the drain of each high-side MOSFET is electrically connected to an input positive terminal Vin+, and the source of each low-side MOSFET is electrically connected to an input negative terminal Vin−;

In each Dr. MOS, an electrical connection point of a source of the high-side MOSFET and a drain of the corresponding low-side MOSFET is a Dr. MOS output terminal, which is denoted as a Switching Node (SW point), and the SW point is electrically connected to an input terminal of an output inductor; an output terminal of each output inductor is electrically connected to an output positive terminal Vo+ of the VRM, and the output positive terminal Vo+ thereof is connected to a load, and provides energy for the load.

FIG. 1B is a schematic circuit diagram of a 16-phase VRM 20, wherein the 16-phase VRM 20 comprises four 4-phase VRMs 10 as shown in FIG. 1A, that is, a 16-phase BUCK circuit; and an output terminal of the 16-phase BUCK circuit is connected in parallel. In this embodiment, sixteen output inductors in the 16-phase BUCK circuit may adopt an integrated 16-phase inductor, or two integrated 8-phase inductors or four integrated 4-phase inductors. Four Dr. MOSs 11 in the 4-phase VRM 10 shown in FIG. 1A are controlled by using a 4-phase PWM control signal, and a phase difference between two adjacent phase PWM control signals is 360 degrees/4, that is, 90 degrees; and a phase difference between four-phase VRMs 10 in FIG. 1B is also 360degrees/4 , that is, 90 degrees.

### Embodiment 1

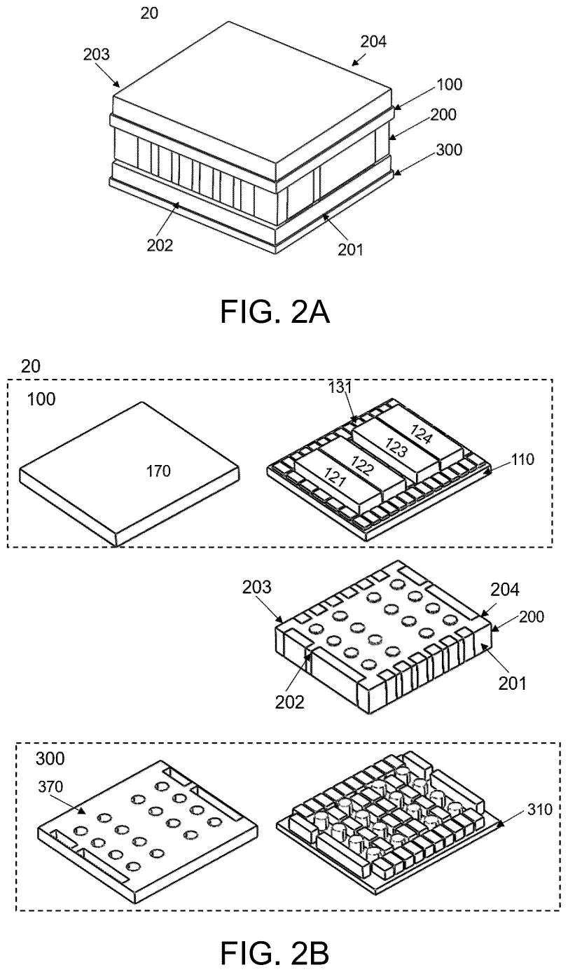

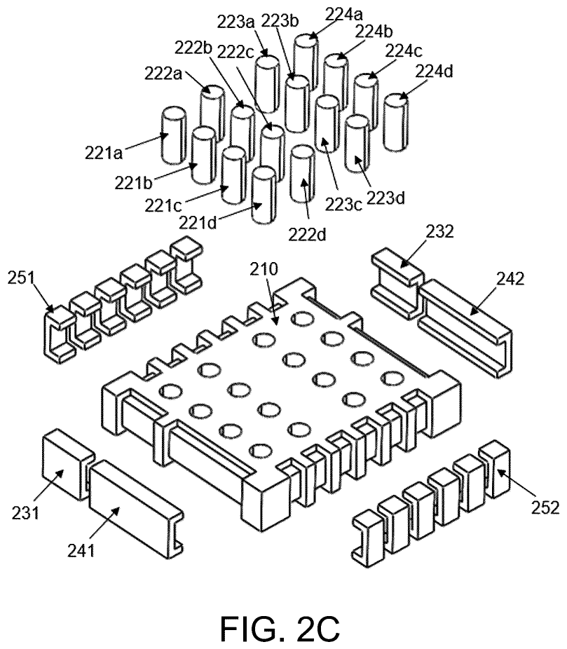

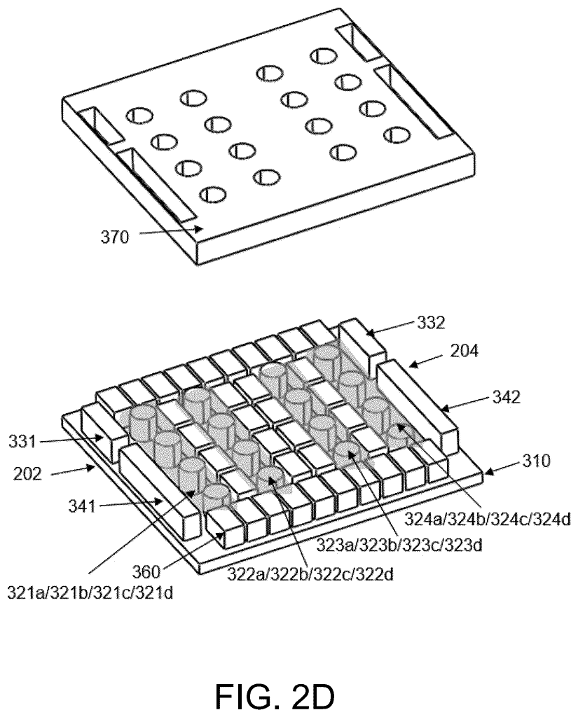

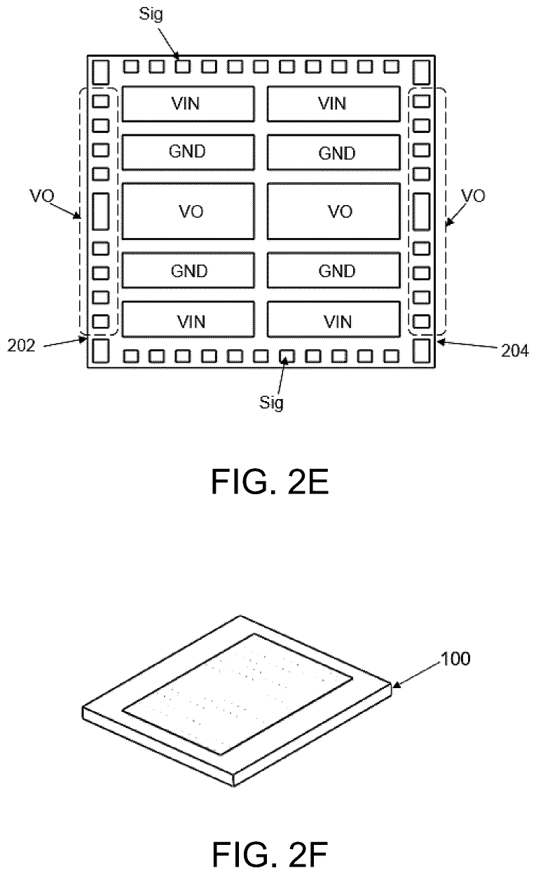

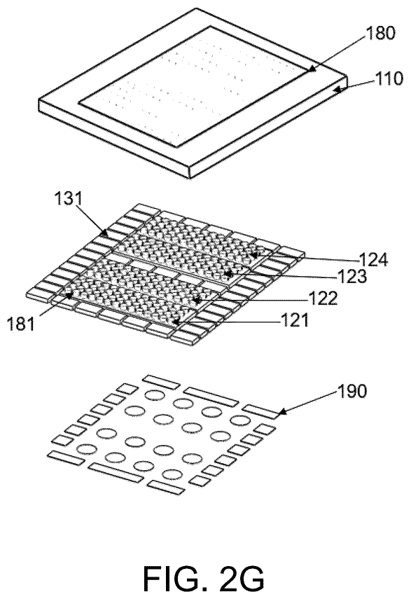

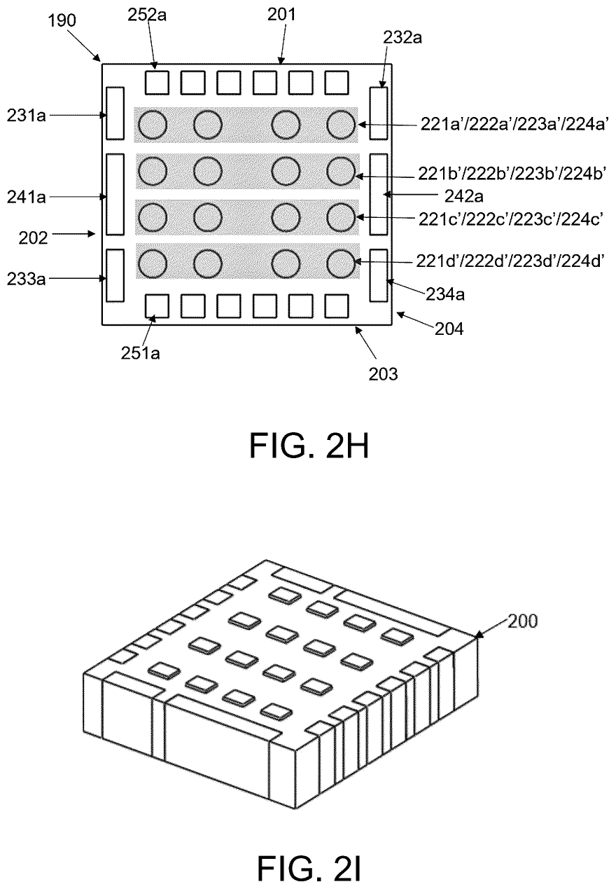

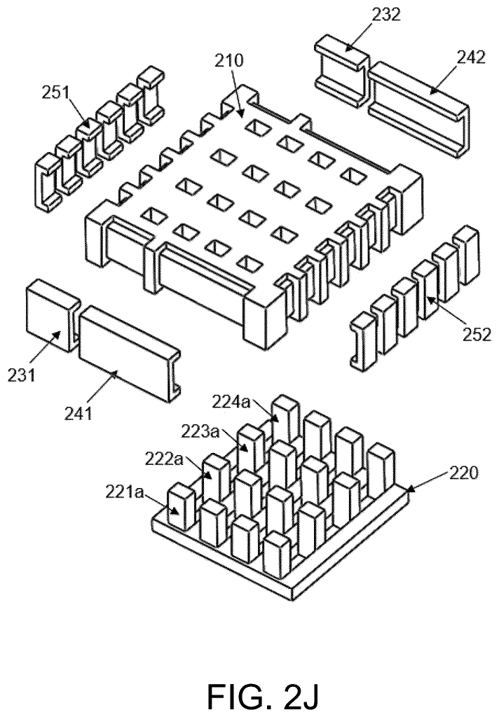

FIG. 2A is a schematic structural diagram of the 16-phase VRM 20 shown in FIG. 1B, and FIG. 2B is an exploded view of the structure of FIG. 2A. As shown in FIGS. 2A and 2B, the 16-phase VRM 20 comprises a top assembly 100, the middle assembly 200 and the bottom assembly 300. The 16-phase VRM 20 comprises a top surface and a bottom surface opposite to each other, a first side surface 201 and a third side surface 203 opposite to each other, and a second side surface 202 and a fourth side surface 204 opposite to each other; here the first side surface 202 to the fourth side surface 204 are also four side surfaces of the top assembly 100, the middle assembly 200 and the bottom assembly 300.

The top assembly 100 comprises a top substrate 110, integrated power stages 121, 122, 123 and 124, an input capacitor 131 and a molding compound 170. Here, each integrated power stage 121, 122, 123 and 124 corresponds to the integrated power stage 11. The input capacitor 131 corresponds to the input capacitor Cin in FIG. 1A. The input capacitors 131 are provided around the integrated power stages 121, 122, 123 and 124 and between the integrated power stage 122 and the integrated power stage 123. The input capacitor 131 may be an MLCC capacitor or a silicon capacitor, but it is not limited thereto. The operating frequency of the power supply module in the present embodiment is high, and the capacitance of the required input capacitor is small. Therefore, the silicon capacitor can not only meet the capacitance requirements, but also reduce the height of the capacitor, thereby reducing the height of the whole power supply module. The Dr. MOS and the input capacitor provided on a top surface of the top substrate 110 are molded together by means of the molding compound 170, so as to protect an element on the top surface of the top substrate, thereby improving the reliability of the power supply module.

FIG. 2C is a structural exploded view of the middle assembly 200, as shown in FIG. 2C, the middle assembly 200 comprises a magnetic core 210, a first winding unit, a second winding unit, a third winding unit, a fourth winding unit, first power electrical connectors 231 and 232, second power electrical connectors 241 and 242 and signal electrical connectors 251 and 252. The first winding unit comprises four first windings, which are 221a, 221b, 221c and 221d respectively; the second winding unit comprises four second windings, which are 222a, 222b, 222c, and 222d respectively; the third winding unit comprises four third windings, which are 223a, 223b, 223c and 222d respectively; the fourth winding unit comprises four fourth windings, which are 224a, 224b, 224c and 224d respectively; and the sixteen windings in the four winding units are arranged in an array of 4×4. The first windings 221a, 221b, 221c and 221d are respectively electrically connected to four SW pins (SW1, SW2, SW3 and SW4) in a first integrated power stage 121; The second windings 222a, 222b, 222c and 222d are respectively electrically connected to the four SW pins in a second integrated power stage 122; the third windings 223a, 223b, 223c and 222d are respectively electrically connected to the four SW pins in a third integrated power stage 123; and the fourth windings 224a, 224b, 224c and 224d are respectively electrically connected to the four SW pins in a fourth integrated power stage 124. Each winding is of an “I”-shaped and is vertically electrically connected to the top assembly 100 and the bottom assembly 300 through the top surface and the bottom surface of the magnetic core 210. Since the 4×4 winding array is arranged directly below the four integrated power stages, the electrical connection impedance between each winding and the corresponding Dr. MOS is small, which is beneficial to the improvement of the efficiency of the power supply module. The sixteen windings can be combined together with the magnetic core in an assembled manner, or can be integrally press-fitted with the magnetic core material to press the magnetic core and the winding together.

The first power electrical connectors 231 and 232 are respectively disposed on the second side surface 202 and the fourth side surface 204 of the magnetic core, the second power electrical connectors 241 and 242 are respectively disposed on the second side surface 202 and the fourth side surface 204 of the magnetic core, the first power electrical connector 231 and the second power electrical connector 241 are adjacent to each other, and the first power electrical connector 232 and the second power electrical connector 242 are adjacent to each other; the power electrical connector may be combined together with the magnetic core in an assembled manner, or may be integrally press-fitted with the magnetic core to press the magnetic core and the power electrical connector together. The signal electrical connectors 251and 252 are respectively disposed on the third side surface 203 and the first side surface 201 of the magnetic core. The signal electrical connectors can be combined together in an assembled manner with the magnetic core, or can be integrally press-fitted with the magnetic core to press the magnetic core and the signal electrical connectors together.

FIG. 2D is a schematic structural diagram of a bottom assembly 300, as shown in FIG. 2D, the bottom assembly 300 comprises a bottom substrate 310, first power metal blocks 331 and 332, second power metal blocks 341/342, an output capacitor 360, a first winding metal block combination, a second winding metal block combination, a third winding metal block combination, a fourth winding metal block combination, and a molding compound 370; the first winding metal block combination comprises four first winding metal blocks, which are 321a, 321b, 321c and 321d respectively; the second winding metal block combination comprises four second winding metal blocks, which are 322a, 322b, 322c and 322d respectively; the third winding metal block combination comprises four third winding metal blocks, which are 323a, 323b, 323c and 323d respectively; the fourth winding metal block combination comprises four third winding metal blocks respectively 324a, 324b, 324c and 324d. The bottom substrate 310 comprises a top surface and a bottom surface opposite to each other, and the first power metal block 331 is disposed on the top surface of the bottom substrate and is disposed adjacent to the second side surface 202; the first power metal block 332 is disposed on the top surface of the bottom substrate and is disposed adjacent to the fourth side surface 204; the second power metal block 341 is disposed on the top surface of the bottom substrate and is disposed adjacent to the second side surface 202; and the second power metal block 342 is disposed on the top surface of the bottom substrate and is disposed adjacent to the fourth side surface 204. The power metal blocks and the winding metal block combinations are both electrically connected to the bottom substrate 310. The first power metal block 331 and the second power metal block 341 are adjacent to each other and are respectively used for electrically connecting to the power electrical connectors 231 and 241; the first power metal block 332 and the second power metal block 342 are adjacent to each other and are respectively used for electrically connecting the power electrical connectors 232 and 242. A projections of each winding metal block and the electrically connected winding on the top surface of the bottom substrate at least partially overlap. The top surface of the bottom substrate 310, the region outside of the first power metal block, the second power metal block, and the winding metal block is used to set the output capacitor 360, and the setting of the output capacitor can further improve the dynamic performance of the VRM output voltage. The power metal block, the output capacitor 360, and the winding metal block are molded together by means of the molding compound 370; and the end surfaces of the power metal blocks and the winding metal blocks are exposed by grinding, and a pin is formed on a top surface of the molding compound 370; and a signal electrical connection pin is implemented by means of a method for metallizing the surface of the molding compound (not shown in the figure), which will not be repeated here.

FIG. 2E is a schematic diagram of a bottom surface pin of the bottom assembly 300 of FIG. 2D, which is a schematic diagram of a bottom surface pin of the bottom substrate 310 in this embodiment. As shown in FIG. 2E, a VO pin, a GND pin, a VIN pin, and a Sig pin are included. The VO pins are disposed at a central position of the bottom substrate, extend from adjacent to the second side surface 202 to adjacent to the fourth side surface 204, the GND pins are respectively disposed on two opposite sides of the VO pins, and extend from adjacent to the second side surface 202 to adjacent to the fourth side surface 204; the VIN pins are respectively arranged on the outer side of the GND pins away from the VO pins, and also extend from the adjacent second side surface 202 to the adjacent fourth side surface 204; and a small pin adjacent to the second side surface 202 and a small pin adjacent to the fourth side surface 204 are also used as VO pins; a small pin adjacent to the first side surface 201 and a small pin adjacent to the third side surface 203 are used as Sig pins; and the current flowing out of each winding metal block converges the current in the winding to the VO pin by means of the bottom substrate 310.

FIG. 2F is another preferred embodiment of the top assembly 100, and FIG. 2G is an exploded view of the structure of FIG. 2F; As shown in FIG. 2F and FIG. 2G, the top assembly 100 shown in the present embodiment comprises the top substrate 110 and integrated power stages 121, 122, 123 and 124 embedded in the substrate, and the input capacitor 131. The input capacitors 131 are arranged around the integrated power stage and between the integrated power stages, so as to achieve a good filtering effect. The top surface of the top substrate 110 is provided with a thermal pad 180, the thermal pad 180 is thermally connected to the integrated power stages 121, 122, 123 and 124 at the top surface by means of a VIA 181; the bottom surface of the top assembly 100 is provided with an internal pin 190. FIG. 2H is the bottom view of FIG. 2F, and the internal pin 190 comprises a first SW pin combination, a second SW pin combination, a third SW pin combination, and a fourth SW pin combination. The first SW pin combination comprises four first SW pins, which are respectively 221a′, 222a′, 223a′ and 224a′; the second SW pin combination comprises four second SW pins, which are respectively 221b′, 222b′, 223b′ and 224b′; the third SW pin combination comprises four third SW pins, which are respectively 221c′, 222c′, 223c′ and 224c′; the fourth SW pin combination comprises four fourth SW pins, which are respectively 221d′, 222d′, 223d′ and 224d′; the SW pins are arranged in the middle region of the bottom surface of the top substrate 110 and are arranged in an array of 4×4, and the 4×4 SW array is used for being electrically connected to a winding pins in the middle assembly. VIN pins 231a, 232a, 233a and 234a are provided at the second side surface 202 adjacent to the top substrate and adjacent to the fourth side surface 204 for being electrically connected to the first power electrical connector in the middle assembly; GND pins 241a and 242a are disposed adjacent to the second side surface 202 of the top substrate and adjacent to the fourth side surface 204 for being electrically connected to the second power electrical connector in the middle assembly; the VIN pins and the GND pins are arranged alternately at a position adjacent to the second side surface 202, the VINs pin and the GND pins are arranged alternately at a position adjacent to the fourth side surface 204; the Sig pins 251a and 252a are respectively disposed adjacent to the third side surface 203 and the first side surface 201 for being electrically connected to the signal electrical connector in the middle assembly.

FIG. 2I is another preferred embodiment of the middle assembly 200 of FIG. 2A, and FIG. 2J is an exploded view of the structure of FIG. 2I; as shown in FIG. 2I and FIG. 2J, the 16-phase winding in the present embodiment is integrated together by means of a lead frame or a stamping, that is, an integrated winding 220; the integrated winding 220 integrates the second ends of the 16 windings on the lead frame, and then is combined with the magnetic core 210, or is integrally press-fitted with the magnetic core. The advantage of the arrangement is that the production efficiency of an integrated inductor is improved; all the windings are converged by means of the lead frame, so that the direct current impedance can be reduced, and the efficiency is improved; and the other electrical connectors are the same as those in the foregoing embodiments, which will not be repeated here.

### Embodiment 2

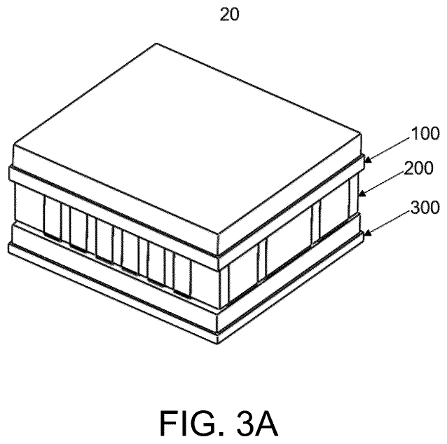

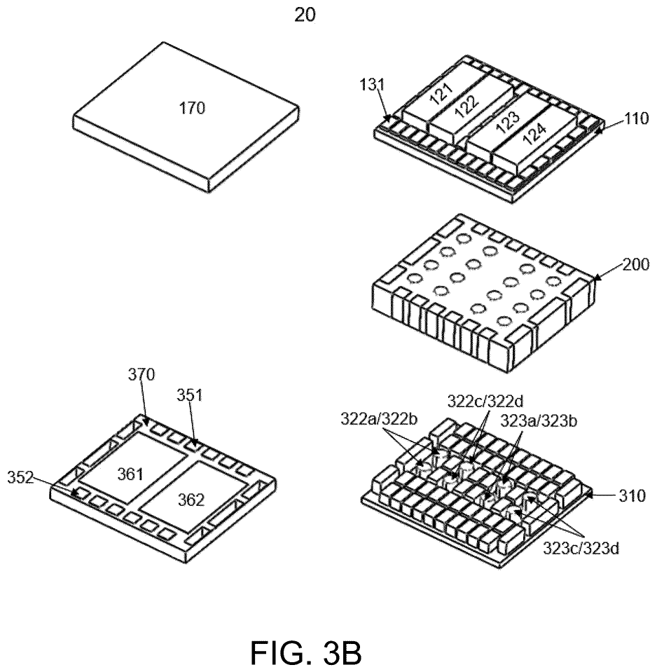

FIG. 3A is a schematic structural diagram of another embodiment of the present application, and FIG. 3B is an exploded view of the structure of FIG. 3A; as shown in FIG. 3A and FIG. 3B, the embodiment of the present embodiment has the same technical effect as the embodiment described in FIG. 2A, the difference in this implementation lies in that the bottom assembly. The number of winding metal blocks of the bottom assembly 300 in this embodiment is less than the number of windings, the top surface of the molding compound 370 is provided with bus pins 361 and 362, the bus pins are used for converging the currents in the 16 windings together, and then transmitting the output current to the VO pin of the bottom surface of the bottom assembly by means of the winding metal blocks 322a, 322b, 322c, 322d, 323a, 323b, 323c, and 323d in the bottom assembly, and supplying power to the load. The number of the winding metal blocks is reduced, more space can be left for setting more output capacitors, and the dynamic performance of the output voltage is further improved.

### Embodiment 3

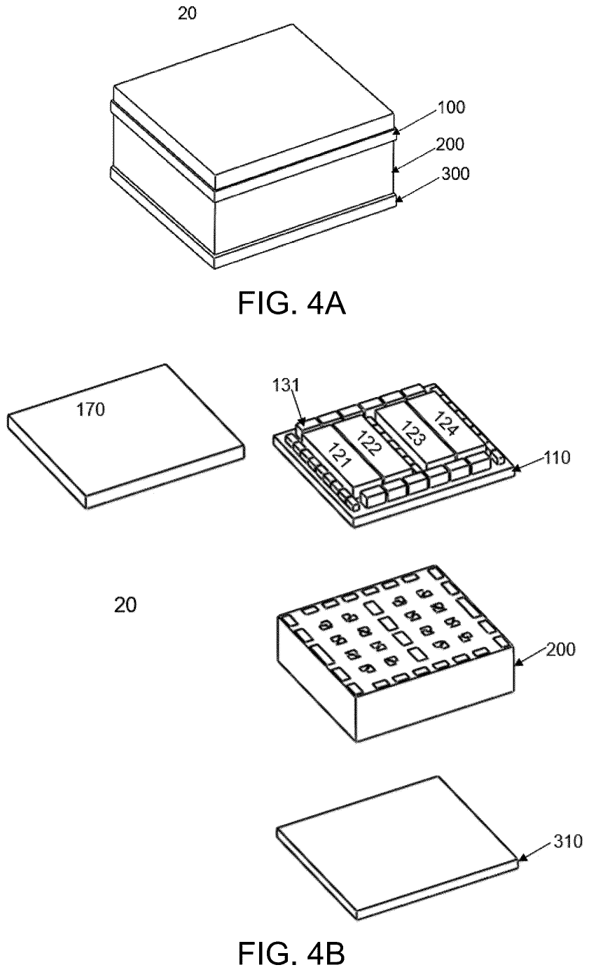

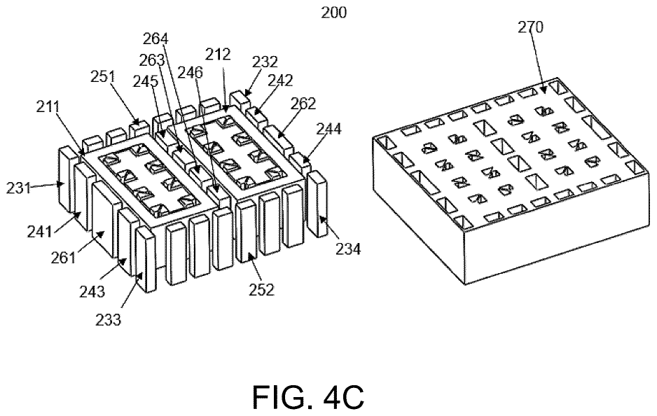

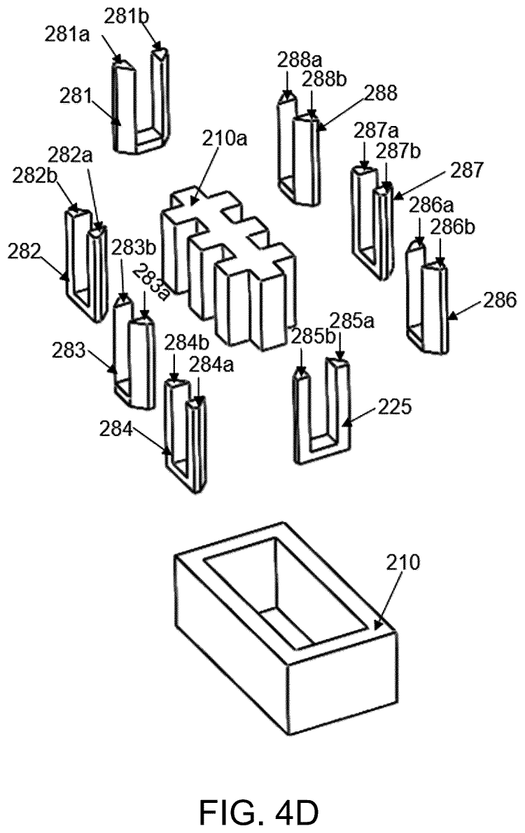

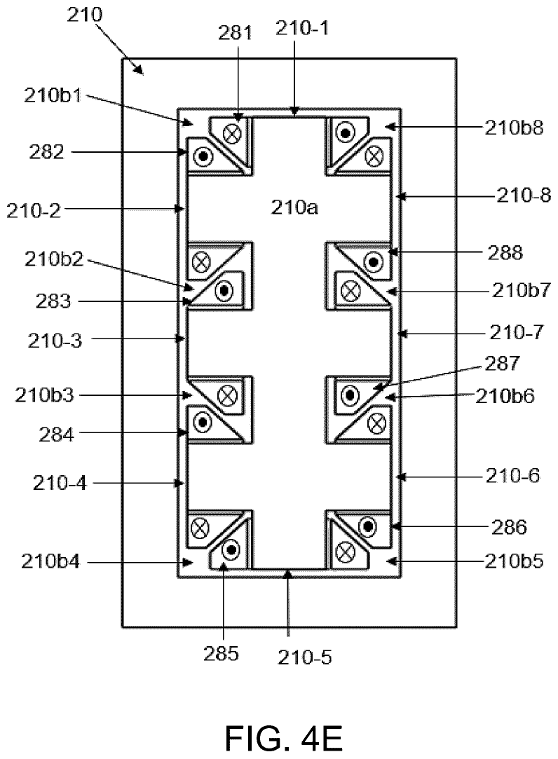

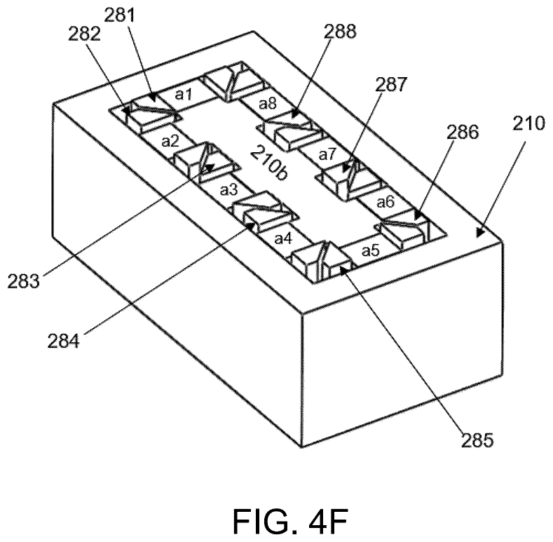

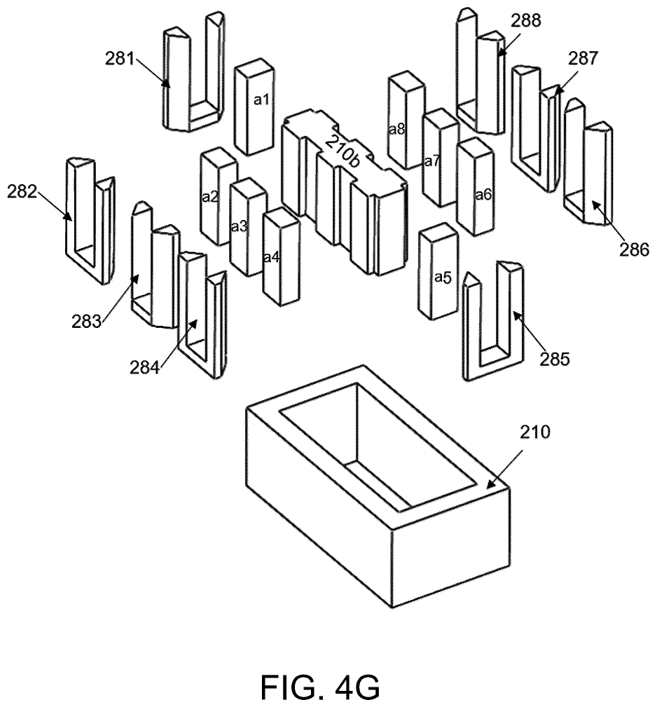

FIG. 4A is a schematic structural diagram of another embodiment of a 16-phase VRM 20 of the present application, and FIG. 4B is an exploded view of the structure of FIG. 4A; as shown in FIG. 4A and FIG. 4B, the 16-phase VRM 20 in this embodiment includes the top assembly 100, the middle assembly 200 and the bottom assembly 300. In this embodiment, the top assembly 100 and the middle assembly 200 may be molded together, and the top assembly 100 and the middle assembly 200 may be formed by double-sided molding on the top surface and the bottom surface of the top substrate 110. The top assembly and the middle assembly may also be molded separately, and then combined together by welding. In this embodiment, the top assembly 100 is the same as the top assembly in FIG. 2A, or the top assembly 100 shown in FIG. 2F can be used, the technical effects thereof are the same, and the same technical effect can also be obtained.

FIG. 4C is a schematic structural diagram of a middle assembly 200 comprising integrated inductors 211 and 212, the first power electrical connectors 231, 232, 233 and 234, the second power electrical connectors 241, 242, 243, 244, 245 and 246, output electrical connectors 261, 262, 263 and 264, the signal electrical connectors 251 and 252 and the molding compound 270.

The integrated inductors 211 and 212 are identical, and are only described by taking 211 as an example. FIG. 4D is an exploded view of the integrated inductor 211 in FIG. 4C; and FIG. 4E is a top view of FIG. 4D. The integrated inductor 211 comprises a first magnetic core 210, a second magnetic core 210a, a first U-shaped winding 281, a second U-shaped winding 282, a third U-shaped winding 283, a fourth U-shaped winding 284, a fifth U-shaped winding 285, a sixth U-shaped winding 286, a seventh U-shaped winding 287, and an eighth U-shaped winding 288. The first magnetic core 210 being in the shape of “□”, and the second magnetic core 210a being in a “+++” shape, i.e. comprising a erected portion and three equal-length horizontal portions, wherein the erected portion vertically passes through the central point of the three horizontal portions; the first magnetic core 210 comprises a middle space for accommodating the second magnetic core 210a; when the second magnetic core 210a is arranged in the middle space of the first magnetic core 210, the middle space of the first magnetic core 210 is divided into eight windows by the second magnetic core 210a, respective are 210b1, 210b2, 210b3, 210b4, 210b5, 210b6, 210b7 and 210b8; In other words, a magnetic core portion between every two adjacent windows, i.e. a magnetic column; the magnetic core in the present embodiment comprises eight magnetic columns, and each U-shaped winding is clamped on a corresponding magnetic column in the same direction. As shown in FIG. 4E, air gaps 210-1, 210-2, 210-3, 210-4, 210-5, 210-6, 210-7 and 210-8 are provided between the first magnetic core 210 and the second magnetic core 210a. As shown in FIG. 4D, the windings in the present embodiment are all “U” shape, each U-shaped winding is provided with two erected parts and one horizontal part, and the two erected parts of any U-shaped winding are respectively arranged in two adjacent windows; the two erected parts of the first U-shaped winding 281 are respectively arranged in a first window 210b1 and a eighth window 210b8; the two erected portions of the second U-shaped winding 282 are respectively arranged in the first window 210b1 and a second window 210b2; the two erected portions of the third U-shaped winding 283 are respectively arranged in the second window 210b2 and a third window 210b3; two erected portions of the fourth U-shaped winding 284 are respectively arranged in the third window 210b3 and a fourth window 210b4; the two v erected portions of the fifth U-shaped winding 285 are respectively arranged in the fourth window 210b4 and a fifth window 210b5; two erected parts of the sixth U-shaped winding 286 are respectively arranged in the fifth window 210b5 and a sixth window 210b6; the two erected parts of the seventh U-shaped winding 287 are respectively arranged in the sixth window 210b6 and a seventh window 210b7; and the two erected parts of the eighth U-shaped winding 288 are respectively arranged in the seventh window 210b7 and the eighth window 210b8.

The magnetic core in the present embodiment is a magnetic material having a high magnetic permeability. Due to the arrangement of air gaps, the coupling coefficient between windings is high. In each winding shown in FIG. 4E, the labeled arrow and arrow tail represent the flow direction of the current. For example, the current in the first U-shaped winding 281 flows from the erected part in the first window 210b1 to the erected part in the eighth window 210b8; the current in the second U-shaped winding 282 flows from the erected part in the second window 210b2 to the erected part in the first window 210b1; the current in the third U-shaped winding 283 flows from the erected part in the third window 210b3 to the erected part in the second window 210b2; the current in the fourth U-shaped winding 284 flows from a erected portion in the fourth window 210b4 to a erected portion in the third window 210b3; the current in the fifth U-shaped winding 285 flows from the erected part in the fifth window 210b5 to the erected part in the fourth window 210b4; the current in the sixth U-shaped winding 286 flows from the erected part in the sixth window 210b6 to the erected part in the fifth window 210b5; the current in the seventh U-shaped winding 287 flows from the erected part in the seventh window 210b7 to the erected part in the sixth window 210b6; the current in the eighth U-shaped winding 288 flows from the erected portion in the eighth window 210b8 to the erected portion in the seventh window 210b7. That is, the current direction of each winding is a counterclockwise direction. In other embodiments, the current direction of each winding can also be set to be clockwise. According to the above arrangement of the current direction, the magnetic flux directions generated by the currents in any two windings are opposite, so that the magnetic fluxes cancel each other. Therefore, an 8-phase inductor in the present embodiment works in an 8-phase anti-coupling state; the anti-coupling inductor can obtain a higher steady-state inductance to improve the conversion efficiency of the power supply module, and meanwhile, a lower dynamic inductance is obtained to improve the transient performance of the power supply module.

In the present embodiment, two pins of the integrated inductor winding (i.e. the two top surfaces of the “U”-shaped winding) are all arranged on the top surface of the middle assembly 200, are all electrically connected to the bottom surface of the top substrate 110, and an input terminal (i.e. one of the two pins) of each winding is electrically connected to the corresponding Dr. MOS by means of the top substrate 110; an output terminal of each winding (i.e. the other of the two pins) is electrically connected to the output electrical connector by means of the top substrate 110. The integrated inductor, the power electrical connector, the output electrical connector and the signal electrical connector are first fixed and electrically connected to the bottom surface of the top substrate, and then the top surface of the top substrate 110 and components on the bottom surface are molded together, and the pins on the bottom surface of the power electrical connector, the output electrical connector, and the signal electrical connector are led out of the molding compound, so as to be electrically connected to the bottom component.

The integrated inductors 211 and 212, the power electrical connector, the output electrical connector, and the signal electrical connector can also be separately molded together with the molding compound 270 to form a package; and the pin of the power electrical connector, the pin of the output electrical connector, and the pin of the signal electrical connector are respectively provided on the top surface and the bottom surface of the package, so as to be electrically connected to the top assembly and the bottom assembly.

FIG. 4F is another preferred embodiment of the integrated inductors 211 and 212 in the present embodiment, and FIG. 4G is an exploded view of the structure of FIG. 4F; the difference of the integrated inductor between the embodiment of FIG. 4F and the embodiment shown in FIG. 4A is to add third magnetic cores a1, a2, a3, a4, a5, a6, a7, and a8, where the third magnetic cores are made of a magnetic material with low magnetic permeability, and has a good direct-current magnetic bias performance; the structure after the third magnetic core and the second magnetic core 210b are assembled is the same as the structure of the second magnetic core 210a shown in FIG. 4D. The arrangement of the third magnetic core reduces the size of the air gap, eliminates the loss problem caused by edge magnetic flux generated by the air gap, and facilitates the improvement of the conversion efficiency of the power supply module.

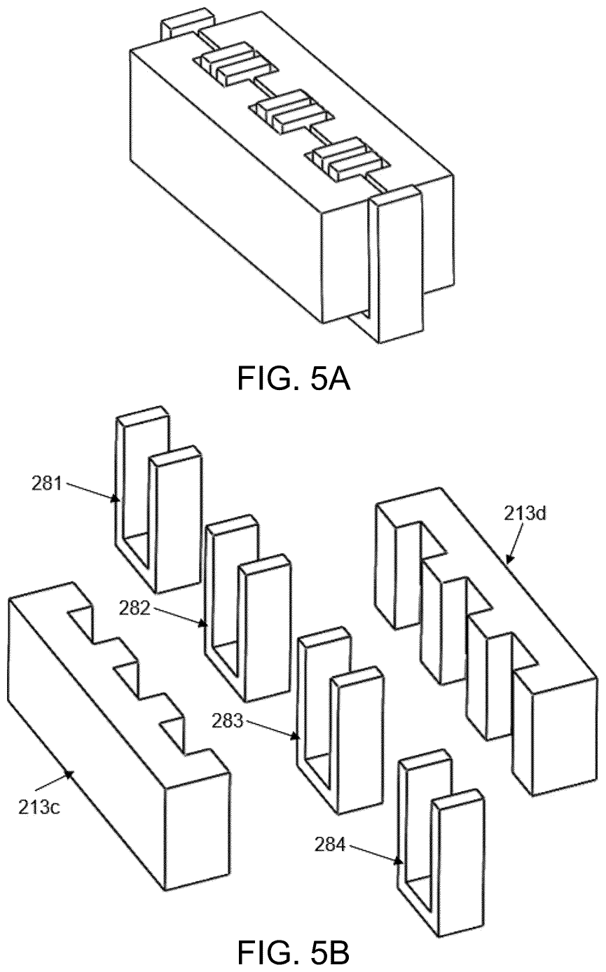

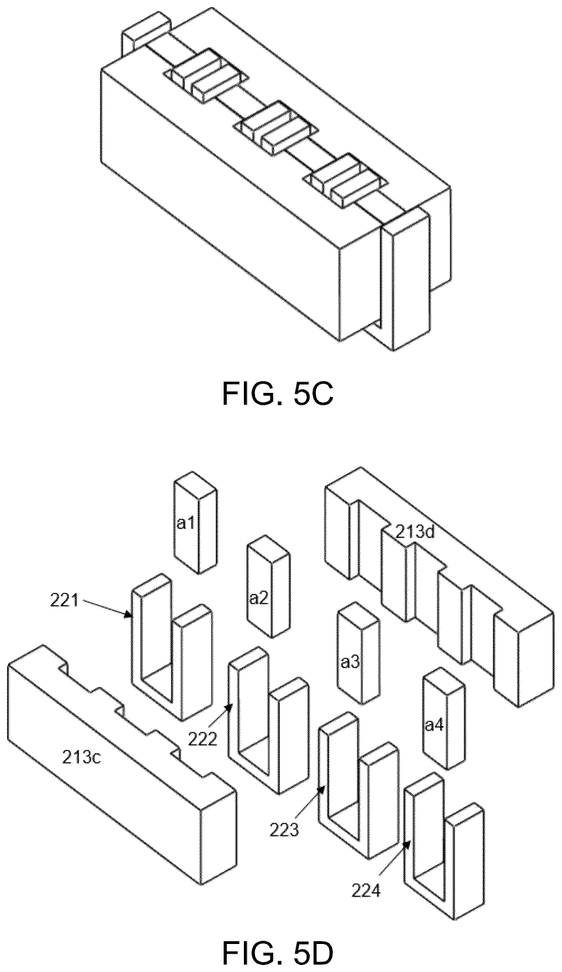

FIG. 5A is another preferred embodiment of the integrated inductors 211 and 212 in the present embodiment, and FIG. 5B is an exploded view of the structure of FIG. 5A. As shown in FIG. 5A and FIG. 5B, the integrated inductors 211 and 212 include a comb-shaped first magnetic core 213c, a comb-shaped second magnetic core 213d, a first U-shaped winding 281, a second U-shaped winding 282, a third U-shaped winding 283, and a fourth U-shaped winding 284; the comb-shaped magnetic cores 213c and 213d comprise four magnetic columns (i.e. four teeth of comb); each U-shaped winding comprises two erected portions and a horizontal portion, and the four U-shaped windings are respectively clamped on one magnetic column of the magnetic core in the same direction; and an air gap is provided in the magnetic column so as to adjust the inductance of each phase winding. Four integrated inductors shown in FIG. 5A are used in the 16-phase VRM in FIG. 4A, and the same technical effect can be achieved. In comparison, the embodiment shown in FIG. 5A is simpler, which is conducive to mass production and manufacturing.

FIG. 5C is a preferred embodiment of FIG. 5A, and FIG. 5D is an exploded view of FIG. 5C; as shown in FIG. 5C and FIG. 5D, the difference between this embodiment and FIG. 5A is that third magnetic cores a1, a2, a3, and a4 are added, the third magnetic core is made of a powder core material with low magnetic permeability, the size of the air gap can be reduced, the loss problem caused by edge magnetic flux generated by the air gap is eliminated, and the conversion efficiency of the power supply module is improved.

In other embodiments, the integrated power stage may also include at least two high-side switching transistors and two low-side switching transistors and a drive/logic circuit. The multi-phase power supply module is not limited to the 16-phase shown in the present application, and can also be at least 4-phase, such as 4-phase, 6-phase, 8-phase, 10-phase, and 12-phase. The structure/quantity of the integrated power stage, the magnetic core structure, and the winding can be combined according to the technical features disclosed in the present application, so that the same technical benefits can be obtained.

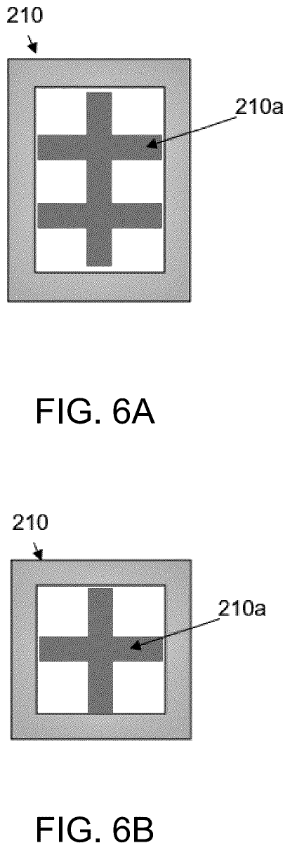

In other embodiments, the multi-phase power supply module may also be an 8-phase VRM, and the multi-phase power supply module includes only one integrated inductor 211 as shown in FIG. 4D or as shown in FIG. 4E. In other embodiments, the multi-phase power supply module may also be a 6-phase VRM, an inductor structure thereof is shown in FIG. 6A, and differs from that shown in FIG. 4D in that the second magnetic core 210a includes a erected portion and two horizontal portions, wherein the erected portion vertically passes through a center point of the two horizontal portions; the second magnetic core 210a is arranged in the middle space of the first magnetic core 210, the second magnetic core 210a divides the middle space of the first magnetic core 210 into six windows, and the erected parts of each U-shaped winding are respectively arranged in two adjacent windows; in other words, after the first magnetic core 210 and the second magnetic core 210a are assembled, equivalent to the magnetic core comprising six magnetic columns, a portion between every two adjacent windows is one magnetic column, and each U-shaped winding is clamped on a corresponding magnetic column in the same direction. By setting the flow direction of the current in each U-shaped winding, an anti-coupling inductor can be realized. Similarly, the multi-phase power supply module may also be a four-phase VRM, an inductor structure thereof is shown in FIG. 6B, and differs from that shown in FIG. 6A in that the second magnetic core 210a of the integrated inductor comprises only one horizontal portion, and the second magnetic core 210a divides the middle space of the first magnetic core 210 into four windows, that is, equivalent to the magnetic core comprising four magnetic columns, and each U-shaped winding is clamped on a corresponding magnetic column in the same direction.

The local technical features of the top assembly, the local technical features of the middle assembly, and the local technical features of the bottom assembly disclosed in the present application can be flexibly combined and applied according to actual requirements, and can also obtain corresponding technical benefits, and are not limited to the above embodiments.

The switch disclosed by the application can be used for realizing the functions of the switch disclosed by the application, such as a Si MOSFET, a SiC MOSFET, a GaN MOSFET or a IGBT MOSFET.

The power supply module according to the embodiment can be an independent module or a part of the electronic device, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A multi-phase power supply module, wherein the multi-phase power supply module is connected in parallel by using a multi-phase BUCK circuit, and the multi-phase power supply module is at least four phases; the multi-phase power supply module comprises a top assembly and a middle assembly; the middle assembly is arranged on a bottom surface of the top assembly, and the middle assembly is electrically connected to the top assembly;
the middle assembly comprises a magnetic core, at least four windings and an electrical connector; the magnetic core comprises at least four magnetic columns, a first side surface and a third side surface opposite to each other, a second side surface and a fourth side surface opposite to each other, and a top surface and a bottom surface opposite to each other; the electrical connector is disposed on a side surface of the magnetic core; and
the windings are all “U” shaped windings, and each “U” shaped winding includes two top surfaces and one bottom surface; each of the windings is clamped on a corresponding magnetic column in the same direction; both top surfaces of each of the “U” shaped windings are electrically connected to the top assembly.

2. The multi-phase power supply module of claim 1, wherein the magnetic core comprises a first magnetic core and a second magnetic core; the second magnetic core includes a erected portion and at least one horizontal portion, the erected portion and the horizontal portions are vertically disposed; the first magnetic core is in a shape of “□”, the first magnetic core includes a middle space, the second magnetic core is disposed in the middle space of the first magnetic core, and the middle space of the first magnetic core is divided into at least four windows.

3. The multi-phase power supply module of claim 2, wherein each of the windings comprises two erected portions and a horizontal portion, and the two erected portions are respectively disposed in two adjacent windows.

4. The multi-phase power supply module of claim 3, wherein current directions flowing through each of the windings are the same.

5. The multi-phase power supply module of claim 3, wherein an air gap is provided between the first magnetic core and the second magnetic core.

6. The multi-phase power supply module of claim 1, wherein the magnetic core is a magnetic material having a high magnetic permeability.

7. The multi-phase power supply module of claim 2, wherein the magnetic core further comprises a third magnetic core, and the third magnetic core is disposed between the first magnetic core and the second magnetic core; and the third magnetic core is a magnetic material having a low magnetic permeability.

8. The multi-phase power supply module of claim 1, wherein the top assembly comprises a top substrate, an integrated power stage, and an input capacitor; the top substrate includes a top surface and a bottom surface opposite to each other, the integrated power stage and the input capacitor are disposed on the top substrate; the integrated power stage includes at least two high-side switches, at least two low-side switches, and a driving/logic circuit; the driving/logic circuit is configured to drive the high-side switches and the low-side switches to be turned on and turned off.

9. The multi-phase power supply module of claim 8, wherein the integrated power stage and the input capacitor are arranged on the top surface of the top substrate; the top assembly further comprises a molding compound, the integrated power stage comprises an integrated Dr. MOS, and the molding compound covers the integrated Dr. MOS and the input capacitor.

10. The multi-phase power supply module of claim 8, wherein the input capacitors are arranged around the integrated power stage and between the integrated power stages, and the input capacitor is an MLCC capacitor or a silicon capacitor.

11. The multi-phase power supply module of claim 9, wherein a top surface of the is provided with a thermal pad, and the thermal pad is thermally connected to a top surface of the integrated power stage through a via.

12. The multi-phase power supply module of claim 8, wherein in the integrated power stage, one of the high-side switches and one of the low-side switches are electrically connected to a SW point, and each of a plurality of the SW points is electrically connected to an input terminal of one of the windings through the top substrate.

13. The multi-phase power supply module of claim 8, wherein the electrical connector comprises a first power electrical connector, a second power electrical connector, an output electrical connector, and a signal electrical connector; the first power electrical connector is electrically connected to an end of the high-side switches by means of the top substrate, and the second power electrical connector is electrically connected to an end of the low-side switches by means of the top substrate; and the output electrical connector is electrically connected to an output terminal of each of the windings by means of the top substrate.

14. The multi-phase power supply module of claim 1, further comprising a bottom assembly; the bottom assembly comprises a bottom substrate, a power metal block, a winding metal block, an output capacitor, and a molding compound; the power metal block comprises a first power metal block and a second power metal block, the bottom substrate comprises a top surface and a bottom surface opposite to each other, the power metal block, the winding metal block, and the output capacitor are arranged on the top surface of the bottom substrate; the molding compound covers the power metal block, the winding metal block, and the output capacitor; the power metal block is electrically connected to a part of the electrical connector, and the winding metal block is electrically connected to one of the windings.

15. The multi-phase power supply module of claim 14, wherein the number of the winding metal blocks is less than or equal to the number of the windings.

16. The multi-phase power supply module of claim 15, wherein projections of each winding metal block and the winding electrically connected to the projections on the top surface of the bottom substrate at least partially overlap.

17. The multi-phase power supply module of claim 15, wherein a top surface of the molding compound is provided with a bus pin, and the bus pin is used for converging the current in the winding.

18. The multi-phase power supply module of claim 1, wherein the magnetic core comprises a first magnetic core and a second magnetic core, the first magnetic core and the second magnetic core are both comb-shaped, and each of the windings is clamped on one tooth of comb in the same direction.

19. The multi-phase power supply module of claim 18, wherein the teeth of comb of the first magnetic core are arranged opposite to the teeth of comb of the second magnetic core.

20. The multi-phase power supply module of claim 19, wherein the magnetic core further comprises a third magnetic core, and the third magnetic core is disposed between the teeth of comb of the first magnetic core and the teeth of comb of the second magnetic core.

21. The multi-phase power supply module of claim 20, wherein the first magnetic core and the second magnetic core are magnetic materials with high magnetic permeability; and the third magnetic core is a powder core material with low magnetic permeability.

22. The multi-phase power supply module of claim 13, wherein an internal pin is provided on the bottom surface of the top assembly, and the internal pin comprises a SW pin, a VIN pin, a GND pin, and a Sig pin;
a plurality of the SW pins are provided in a middle region of the bottom surface of the top assembly and are electrically connected to a winding pin; a plurality of the VIN pins are disposed adjacently on a second side surface and a fourth side surface of the top assembly, and are electrically connected to the first power electrical connector; a plurality of the GND pins are disposed adjacently on the second side surface and the fourth side surface of the top assembly, and are electrically connected to the second power electrical connector; and a plurality of the Sig pins are disposed adjacently on a third side surface and a first side surface of the top assembly, and are electrically connected to the signal electrical connector.

23. A multi-phase power supply module, wherein the multi-phase power supply module is adopting a paralleled multi-phase BUCK circuit, and the multi-phase power supply module is at least four phases; the multi-phase power supply module comprises a top assembly, a middle assembly and a bottom assembly; the middle assembly is arranged between the top assembly and the bottom assembly, and the middle assembly is electrically connected to the top assembly and the bottom assembly;
the middle assembly comprises a magnetic core, at least four windings, and an electrical connector; the magnetic core comprises at least four magnetic columns, a first side surface and a third side surface opposite to each other, a second side surface and a fourth side surface opposite to each other, and a top surface and a bottom surface opposite to each other; the electrical connector is disposed on a side surface of the magnetic core; each of the windings is an “I”-shaped winding, each winding passes through the top surface and the bottom surface of the magnetic core, and is electrically connected to the top assembly and the bottom assembly respectively; the at least four windings are arranged in a winding array; and
the top assembly includes a top substrate and an integrated power stage, the winding array is disposed below the integrated power stage.

24. The multi-phase power supply module of claim 23, the top assembly further comprising an input capacitor; the top substrate comprises a top surface and a bottom surface opposite to each other, and the integrated power stage and the input capacitor is arranged on the top surface of the top substrate; the integrated power stage includes at least two high-side switches, at least two low-side switches, and a driving/logic circuit; the driving/logic circuit is configured to drive the high-side switches and the low-side switches to be turned on and turned off.

25. The multi-phase power supply module of claim 24, wherein the electrical connector comprises a first power electrical connector, a second power electrical connector, and a signal electrical connector; the first power electrical connector is electrically connected to an end of the high-side switches by means of the top substrate, and the second power electrical connector is electrically connected to an end of the low-side switches by means of the top substrate.

26. The multi-phase power supply module of claim 25, wherein the first power electrical connector is disposed on a second side surface and a fourth side surface of the magnetic core, the second power electrical connector is also disposed on the second side surface and the fourth side surface of the magnetic core, and the first power electrical connector and the second power electrical connector on the same side surface are adjacent to each other.

27. The multi-phase power supply module of claim 26, wherein the bottom assembly comprises a bottom substrate, a power metal block, a winding metal block, an output capacitor, and a molding compound; the power metal block comprises a first power metal block and a second power metal block, the bottom substrate comprises a top surface and a bottom surface opposite to each other, the power metal block, the winding metal block and the output capacitor are arranged on the top surface of the bottom substrate; the molding compound covers the power metal block, the winding metal block, and the output capacitor; the power metal block is electrically connected to a part of the electrical connector, and the winding metal block is electrically connected to the windings.

28. The multi-phase power supply module of claim 27, wherein the first power metal blocks are disposed adjacently on a second side surface and a fourth side surface of the bottom substrate; a plurality of the second power metal blocks are also disposed adjacently on the second side surface and the fourth side surface of the bottom substrate; the first power metal block and the second power metal block, which are disposed adjacently on the second side surface of the bottom substrate, are respectively electrically connected to the first power electrical connector and the second power electrical connector on the second side surface of the bottom substrate; and the first power metal block and the second power metal block, which are disposed adjacently on the fourth side surface of the bottom substrate, are respectively electrically connected to the first power electrical connector and the second power electrical connector on the fourth side surface of the bottom substrate.

29. The multi-phase power supply module of claim 27, wherein the bottom substrate has a bottom surface pin; the bottom surface pin comprises a VO pin, a GND pin, a VIN pin, and a Sig pin; a plurality of the VO pins are disposed at a central position of the bottom substrate, extend from adjacent to the second side surface of the bottom substrate to adjacent to the fourth side surface of the bottom substrate; a plurality of the GND pins are respectively disposed on two opposite sides of the VO pins, and also extend from adjacent to the second side surface of the bottom substrate to adjacent to the fourth side surface of the bottom substrate; a plurality of the VIN pins are disposed on a outer side of the GND pins away from the VO pins, and also extend from the adjacent to the second side surface of the bottom substrate to adjacent to the fourth side surface of the bottom substrate; and
a pin adjacent to the second side surface of the bottom substrate and a pin adjacent to the fourth side surface of the bottom substrate are used as the VO pins; a pin adjacent to a first side surface of the bottom substrate and a pin adjacent to a third side surface of the bottom substrate are used as a plurality of the Sig pins.

30. The multi-phase power supply module of claim 23, wherein the at least four windings are combined into an integrated winding by means of a lead frame or a stamping.
